(19) United States
(12) Patent Application Publication
(10) Pub. No.: US 2014/0232544 A1
(43) Pub. Date: Aug. 21, 2014

(54) ADHESIVE-BONDED ARTICLE PROTECTION TAG

(71) Applicants: Yannan Yang, Shanghai (CN); Ming Fang, Shanghai (CN); Yinghua Xu, Shanghai (CN); Yunyue Yang, Shanghai (CN); Ming-Ren Lian, Boca Raton, FL (US); Nen-Chin Liu, Wellington, FL (US); Hubert A. Patterson, Boca Raton, FL (US); Wing Kei Ho, Boynton Beach, FL (US)

(72) Inventors: Yannan Yang, Shanghai (CN); Ming Fang, Shanghai (CN); Yinghua Xu, Shanghai (CN); Yunyue Yang, Shanghai (CN); Ming-Ren Lian, Boca Raton, FL (US); Nen-Chin Liu, Wellington, FL (US); Hubert A. Patterson, Boca Raton, FL (US); Wing Kei Ho, Boynton Beach, FL (US)

(21) Appl. No.: 13/840,480

(22) Filed: Mar. 15, 2013

(30) Foreign Application Priority Data
Feb. 20, 2013 (CN) 201310053823.6

(51) Int. Cl. G08B 13/24

(52) U.S. Cl. CPC G08B 13/2434
USPC 340/572.8; 427/208.2

(57) ABSTRACT

A security system tag. The security system tag includes a housing. The security system tag further includes an electronic article surveillance, EAS, element in which the EAS element is arranged to emit a detectable signal when introduced to an interrogation signal. The security system tag further includes a metal element in which the metal element is adapted to be heated. The security system tag further includes a first reversible adhesive proximate the metal element in which at least a portion of the first reversible adhesive de-bonds when thermally affected by the metal element when the metal element is heated.

### STATEMENT REGARDING FEDERALLY SPONSORED RESEARCH OR DEVELOPMENT

n/a

### FIELD OF THE INVENTION

The present invention relates generally security system anti-theft tags, and more specifically to a method and system for security tag attachment using a reversible adhesive.

### BACKGROUND OF THE INVENTION

Electronic article surveillance (“EAS”) systems are commonly used in retail stores and other settings to prevent the unauthorized removal of goods from a protected area. Typically, a detection system is configured at an exit from the protected area, which comprises one or more transmitters and antennas (“pedestals”) capable of generating an electromagnetic field across the exit, known as the “interrogation zone.” Articles to be protected can be tagged with security tags including an EAS marker that, when active, generates a response signal when passed through this interrogation zone. An antenna and receiver in the same or another “pedestal” detects this response signal and generates an alarm.

The security tag can also include an RFID element. The RFID element that is commonly incorporated in retail stores and is used in conjunction with an RFID reader. When the RFID element is within the interrogation zone of the RFID reader, the RFID element may be activated and provide information regarding the item associated with the RFID element (e.g., product description, serial number, location, etc.). In particular, the RFID element receives and responds to radio frequency (“RF”) signals to provide information related to the item that is within range of the RFID reader.

However, in certain scenarios, attachment of these security tags may damage the item the tag is meant to protect. Most conventional hard tags require a hole to be punctured into the item to be protected. This may damage the item. In particular, the movement of the EAS/RFID security tag as a consumer touches at or puts on an item may further increase the size of the initial puncture hole caused by the clamp, thereby damaging the item. While placement of the hard tag on a specific part of the item may help conceal this damage, the item has nevertheless been damaged and may cause a consumer to think twice about purchasing the item. As such, conventional hard tag mechanisms employed to protect an item may in turn end up damaging the item and causing the consumer not to purchase the item.

Moreover, often these hard tags rely on mechanical locking mechanisms to affix the tag to an article. For example, after the pin is inserted, through the item, into tag, a mechanical pin-retaining clutch engages the inserted pin such as to inhibit pin removal. However, incorporating a mechanical pin-retaining clutch often results in added production cost as manual labor is required during several production steps. In other words, mechanical locking mechanisms that require manual labor cannot be produced through a cost efficient automated production process.

Non-hard tag solutions may help prevent possible damage from hard tags and may be relatively low in cost, but lack the level of security of the hard tag attachment mechanism. One commonly used non-hard tag solution uses swing tickets including EAS/RFID labels. For example, a swing ticket made from cardstock may include EAS/RFID mechanisms in which the swing ticket is typically attached to an item such as clothing and other goods using thin plastic tagging pins. The plastic tagging pins are attached using a tagging gun that pierces the item to insert the pin and the swing ticket. However, the swing ticket may be easily removed without the use of tools since the ticket can be either torn away from the pin or the pin manipulated to allow the extraction of the ticket. Even if the swing ticket itself is strengthened, e.g., by using hard plastic, it is still defeatable, thereby, leaving the item unprotected from possible theft.

Therefore, what is needed is a system and method for a security tag application system with an attachment mechanism which is lower in cost than current hard tag attachment systems, but has a higher level of security than provided by swing tickets. Moreover, there is a need for a security tag with an attachment mechanism that does not damage the item the tag was meant to protect.

### SUMMARY OF THE INVENTION

The present invention provides a method and system for a security tag such as a security tag using reversible adhesives to removably affix the tag to an article.

One aspect of the invention provides a system in which a security tag has an outer surface and an inner volume. The tag includes at least one of an Electronic Article Surveillance (EAS) element and a Radio Frequency Identification (RFID) element disposed within the inner volume. The system also includes a reversible adhesive disposed on at least a portion of the outer surface.

Another aspect of the invention provides an apparatus in which a security tag has an exterior surface, an interior surface, an inner volume and at least one aperture. The tag includes at least one of an Electronic Article Surveillance (EAS) element and a Radio Frequency Identification (RFID) element disposed within the inner volume. The aperture defines a passage to the interior surface. A reversible adhesive is disposed on at least a portion of the interior surface of the tag. At least one cable being removably insertable within the at least one aperture. The cable is detachably couplable to the reversible adhesive.

Still another aspect of the invention provides an apparatus in which a security tag has an inner volume and at least one of an Electronic Article Surveillance (EAS) element and a Radio Frequency Identification (RFID) element disposed within the inner volume. An anchoring element having a first end removably affixes the security tag to an article. A reversible adhesive is disposed on at least a portion of the first end of the anchoring element.

Still another aspect of the invention provides a loss prevention system for protecting an article. The system includes a security tag. The security tag includes a housing and a metal element in which the metal element adapted to be heated. The security tag further includes a first reversible adhesive proximate the metal element. At least a portion of the first reversible adhesive de-bonds when thermally affected by the metal element when the metal element is heated.

Still another aspect of the invention provides a security system tag. The security system tag includes a housing. The security system tag further includes an electronic article surveillance, EAS, element in which the EAS element is arranged to emit a detectable signal when introduced to an interrogation signal. The security system tag further includes a metal element in which the metal element is adapted to be heated. The security system tag further includes a first reversible adhesive proximate the metal element in which at least a portion of the first reversible adhesive de-bonds when thermally affected by the metal element when the metal element is heated.

Still another aspect of the invention provides a method. A first reversible adhesive is applied to a bonding surface of a security tag that includes an EAS element and a metal element. The first reversible adhesive is arranged to releasably attach the security tag to an article and de-bond when thermally affected by the metal element when the metal element is heated.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an exemplary embodiment of the security tag system constructed in accordance with the principles of the present invention;

FIG. 2 is a side view of the embodiment of FIG. 1;

FIG. 3 is a perspective view of an alternative embodiment of the security tag system constructed in accordance with the principles of the present invention;

FIG. 4 is a perspective view of still another alternative embodiment of the security tag system constructed in accordance with the principles of the present invention;

FIG. 5 is a view of an open hard tag with reversible adhesive in the interior in accordance with the principles of the present invention;

FIG. 6 is a side view of an embodiment of the security tag system using an adhesive coated button in accordance with the principles of the present invention;

FIG. 7 is a side view of an alternative embodiment of the security tag system using an adhesive coated button in accordance with the principles of the present invention;

FIG. 8 is a flow chart of an exemplary security tag application and removal process in accordance with the principles of the present invention;

FIG. 9 is a perspective view of an alternative embodiment of the security tag system in accordance with the principles of the present invention;

FIG. 10 is a cross-sectional view of an alternative embodiment of a tag in accordance with the principles of the present invention;

FIG. 11 is a cross-sectional view of another alternative embodiment of a tag having a metal element with extended portions in accordance with the principles of the present invention;

FIG. 12 is a cross-sectional view of still another alternative embodiment of a tag having metal element distributed through a reversible adhesive layer in accordance with the principles of the present invention;

FIG. 13 is a cross-sectional view of another alternative embodiment of a tag having metal or ferromagnetic particles distributed throughout a reversible adhesive layer in accordance with the principles of the present invention;

FIG. 14 is a cross-sectional view of another alternative embodiment of a tag in accordance with the principles of the present invention;

FIG. 15 is an exploded view of another alternative embodiment of a tag in accordance with the principles of the present invention;

FIG. 16 is an exploded view of still another alternative embodiment of a tag in accordance with the principles of the present invention;

FIG. 17(a)-(b) illustrates different embodiments of a metal element in accordance with the principles of the present invention;

FIG. 18 is a perspective view of an exemplary tag removal device in accordance with the principles of the present invention;

FIG. 19 is a flow chart of a process for producing a tag in accordance with the principles of the present invention; and

FIG. 20 is a flow chart of a process for producing an alternative embodiment of a tag in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components steps related to implementing a method and system for security tag deployment using reversible adhesives, and more specifically to a method and system for security tag attachment and removal using a reversible adhesive. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

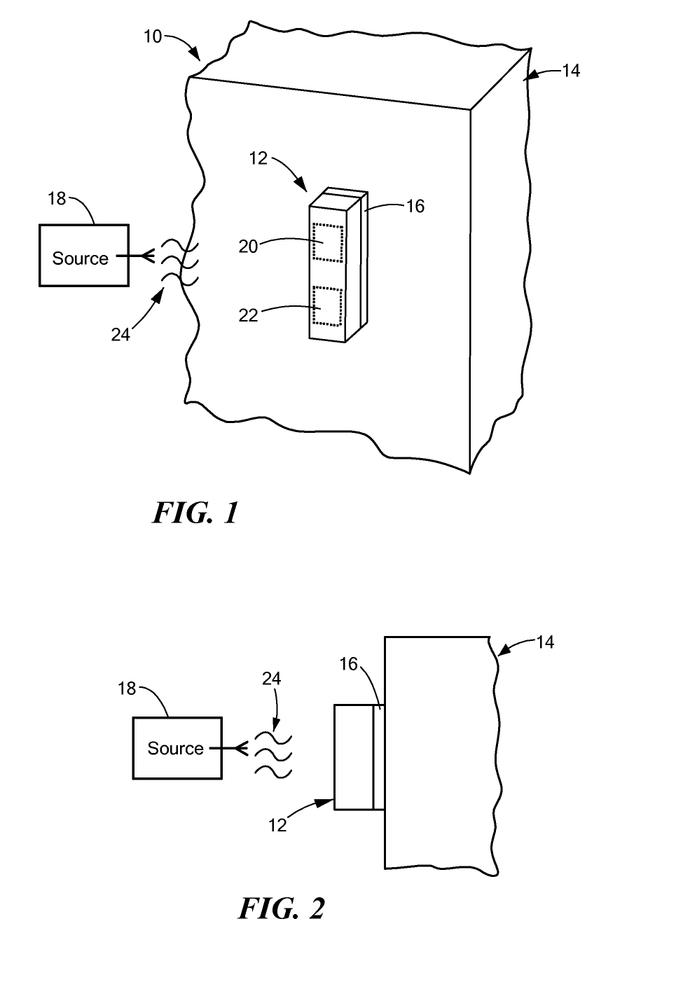

One embodiment of the present invention advantageously provides a method and system for security tag attachment using a reversible adhesive. Referring now to the drawing figures, in which like reference designators refer to like elements, there is shown in FIG. 1 a system constructed in accordance with the principles of the present invention and designated generally as “10.” System 10 may include a tag 12, article 14, reversible adhesive 16 and source 18. The interior of the tag 12 may include an EAS element 20 and/or an RFID element 22. The article 14 may be composed of any tangible medium to which the reversible adhesive 16 may bond. The tag 12 includes an exterior and interior surface. The reversible adhesive 16 can be disposed on the exterior or interior surface based on implementation considerations as discussed herein. The source 18 may include a signal generator that generates a signal 24 to thermally affect the reversible adhesive 16.

In particular, with reference to FIG. 1, the tag 12 may include an EAS element 20, RFID element 22 and/or other elements disposed within the tag 12. The tag 12 may be a hard tag, label, among others types known in the art. The tag 12 may be a hollow shell composed of plastic or other materials known in the art. The EAS element 20 may be composed of a magnetic element, acousto-magnetic element, microwave element, radio frequency element and the like. The EAS element 20 may function to receive and transmit signals. The RFID element 22 may include a radio frequency element that receives and transmits RF signals. The particular configurations and functions of the EAS element 20 and RFID element 22 are well known in the art and will not be further discussed.

As illustrated in FIG. 1, the article 14 may have at least one surface to which the adhesive may be adhered, i.e., bonded or coupled. The article 14 may be configured to any shape including geometric, non-geometric or a combination thereof. For example, the article 14 may be a box or container. The article 14 may include a porous surface having pores of sufficient size to allow the adhesive to enter the pores, thereby constructing a bond with the article 14 when the adhesive hardens or cures. Other surface types may also be used in accordance with the invention. Moreover, the article 14 may include tangible articles such as clothes, packaging, products and the like. Specifically, the article 14 may include fabric, plastic, cardboard, ceramics, metals, polymers and the like.

Still referring to FIG. 1, the adhesive used to detachably couple the tag 12 to the article 14 may be a reversible adhesive 16. The reversible adhesive 16 may include any adhesive that may temporarily or permanently release, i.e., debond, uncure, soften and the like, from a surface upon application of an energy source. For example, the signal 24 may be applied to the reversible adhesive 16 to thermally affect the adhesive, thereby causing the adhesive to release. The reversible adhesive 16 may be composed of an adhesive containing additives such as ferromagnetic or metallic particles. When a high frequency electromagnetic (EM) field is applied to the reversible adhesive 16, the paramagnetic particles will oscillate and, in turn, heat the adhesive, i.e., thermally affect the adhesive. Alternatively, a different additive may be added to the reversible adhesive 16 so as to induce coupling of an electromagnetic field, thereby generating an electric current that will heat the reversible adhesive 16 causing the adhesive to release. Moreover, other types of reversible adhesives that release when an energy source is applied may be used in accordance with the principles of the invention. As such, the reversible adhesive 16 may detachably couple the tag 12 to the article 14 by thermally affecting the reversible adhesive 16. Also, depending on the specific reversible adhesive 16 used, the reversible adhesive 16 may be detachably coupled numerous times, e.g., the tag 12 may be reused.

Referring to FIG. 1, the source 18 is adapted to supply energy to the reversible adhesive 16 so as to thermally affect the adhesive. For example, the source 18 may include an EM field generator that produces an EM signal 24 at a frequency or various frequencies. The EM signal 24 may be applied to the reversible adhesive 16 causing the reversible adhesive 16 to release. Also, the intensity of the generated EM signal 24 may be varied in order to produce a greater or lesser thermal response from the reversible adhesive 16, e.g., induce a greater response from the paramagnetic particles, induce a greater current or the like. An EM signal 24 of greater intensity may also enable the EM field to travel a greater distance, thereby allowing the source 18 to be positioned a greater distance from the tag 12. It is also contemplated that the reversible adhesive 16 can be made sensitive to multiple frequencies such that the reversible adhesive needs two or more different signals, i.e., signals at different frequencies, in order to release. Such an arrangement provides increased security by making it more difficult for a wrongdoer to tamper with the adhesive. The specific type of EM field generator used may depend on various factors such as size, cost, power consumption, frequency generation, signal strength and the like.

Moreover, the source 18 may include other types of energy generators such as a voltage generator, current generator and the like, that may be applied directly to the reversible adhesive 16 and/or tag 12. For example, the voltage generator may apply a voltage to a pair of contact points on the tag 12 in order to generate a current across the reversible adhesive 16, thereby thermally affecting the reversible adhesive 16. The contact points may include signal traces or may be points directly on the reversible adhesive 16.

With reference to FIG. 1, the tag 12 may be configured to detachably couple with the article 14 using a non-mechanical mechanism, i.e., non-moving mechanical parts, by using the reversible adhesive 16. This configuration may allow for a smaller tag profile that may be more tamper resistant and easier to hide on the article 14 then conventional tags. Also, this configuration may reduce the cost and time of production, e.g., simplify manufacturing, use less materials and the like.

Also, using the reversible adhesive 16 may allow the tag 12 to be detached from the article 14 without causing damage to either the article 14 or the tag 12. Specifically, none or substantially none of the article is torn off upon removal of the tag 12 from the article 14. Also, the use of the EM signal 24 may not damage the article 14, nor may the thermal energy generated by the EM signal 24 damage the article 14, e.g., the generated heat does not damage the article. Accordingly, the tag 12 incorporating a reversible adhesive 16 may be detached from the article 14 without causing damage to the article 14.

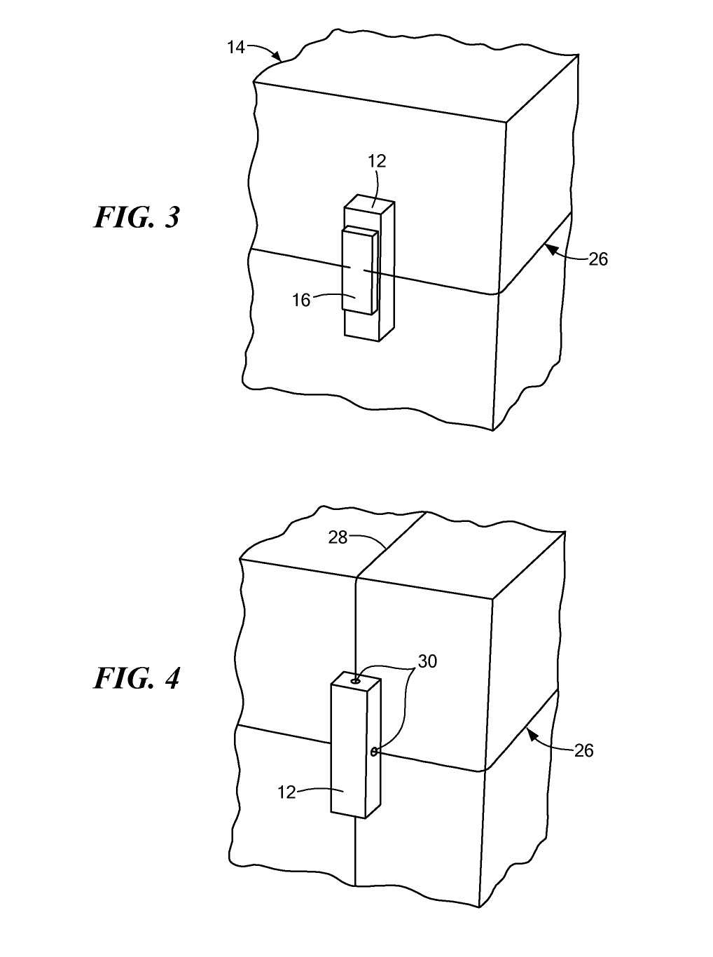

FIG. 2 illustrates a side view of the embodiment of FIG. 1 in which the reversible adhesive 16 may be used to detachably couple the tag 12 to the article 14, e.g., to a container. In particular, the reversible adhesive 16 may be coated to an exterior surface of the tag 12 that may be detachably coupled to a portion of the article 14, e.g., the reversible adhesive 16 may be coated to a portion or to an entire side of the tag 12. The amount of reversible adhesive 16 disposed on the tag, e.g., thickness and area, may be varied as these and other criteria may affect the time needed for the reversible adhesive 16 to bond or release, i.e., a smaller reversible adhesive 16 area may require less time to bond.

Referring to FIG. 3, there is illustrated an alternative embodiment of the tag 12 with reversible adhesive 16. In particular, the tag 12 includes the reversible adhesive 16 on an exterior surface not facing the article 14, e.g., on a surface opposite the side facing the article 14. In this configuration, the reversible adhesive 16 may be used to detachably couple one or more ends of a cable 26 to the tag 12. For example, as illustrated in FIG. 3, both ends of the cable 26 are detachably coupled to the reversible adhesive. In particular, the source 18 may be used to release the reversible adhesive 16 in order to detachably couple the cable ends to the tag 12, or to decouple the cable ends from the tag 12 in order to remove the tag 12. The cable 26 may include a strand or multiple strands of wire, rope and the like, made of metal, nylon, and the like. Moreover, the cable may be composed of a material to which the reversible adhesive 16 may bond. The cable ends that are detachably coupled to the reversible adhesive 16 may also be varied. For example, the cable ends may have a greater width than the cable 26 so as to detachably couple a greater portion of the cable end to the reversible adhesive 16, e.g., flat cable ends.

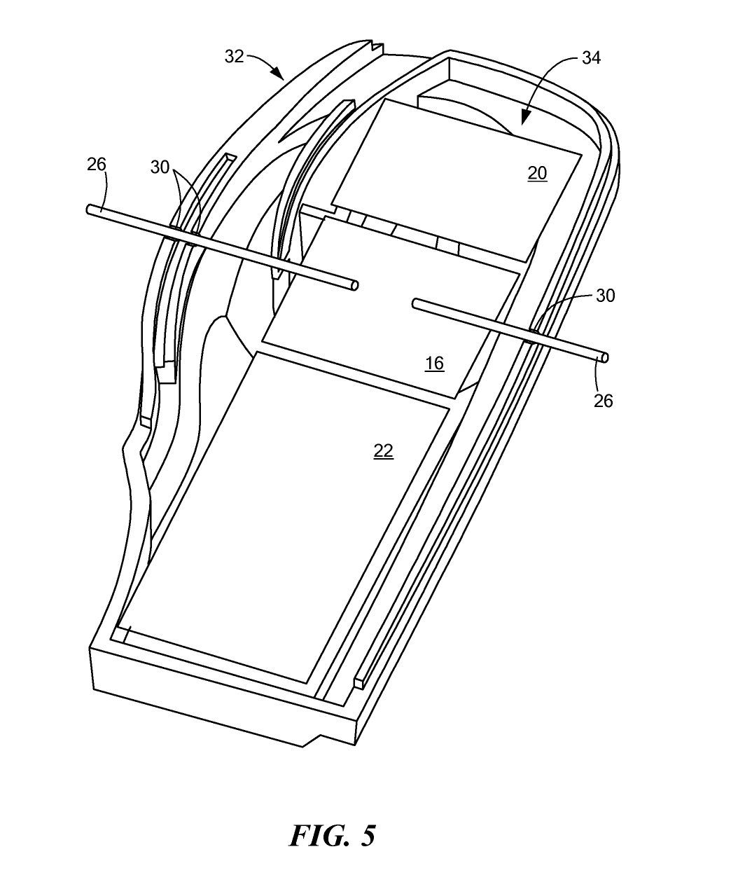

Also, additional cables, e.g., cable 28 in FIG. 4, may be detachably coupled to the reversible adhesive 16. For example, one or more cables may be added to the configuration of FIG. 3 in which the one or more cables may wrap around the entire or a portion of article 14. The ends of the one or more cables may be detachably coupled to the tag 12. The addition of one or more cables may serve to further secure the tag 12 to the article 14, i.e., may make the tag 12 harder to remove without the use of the source 18.

Alternatively, one end of the cable 26, 28 may be permanently coupled to the tag 12 via a mechanical mechanism, permanent adhesive or other mechanisms known in the art. In other words, one end of the cable 26 may be affixed to the tag 12 while the other end may be detachably coupled to the reversible adhesive 16. This configuration may make tag attachment easier, i.e., may be easier for one person to attach the tag 12.

Also, the tag 12 illustrated in FIG. 3 may have an additional reversible adhesive coating on the outer surface facing the article 14 (not shown). In particular, using a tag 12 having two sides coated with the reversible adhesive 16 and at least one cable 26 may significantly increase the tamper resistance of the tag 12, i.e., a thief will have a harder time removing the tag 12 without damaging the article 14. Moreover, the tag 12 may be easier to attach to the article 14. For instance, the tag 12 may first be detachably coupled to the article 14 and then the cable 26 may be detachably coupled to the tag 12 without having to hold the tag 12 in place, i.e., the tag 12 is already detachably coupled to the article 14 using a reversible adhesive. Also, the additional reversible adhesive coating may be added to the tag 12 illustrated in FIG. 4, discussed below.

Referring to FIG. 4, an alternative embodiment of the tag 12 is illustrated. Specifically, the reversible adhesive 16 may be disposed on an interior area or surface within the tag 12 so as to detachably couple at least one cable end to the tag 12, e.g., cables 26 and/or 28. In particular, the tag 12 may have one or more apertures 30 disposed on one or more sides of the tag 12. Each aperture 30 leads to the interior area coated with the reversible adhesive 16, i.e., the cable end may be removably insertable into the aperture 30. The source 18 may be applied to the tag 12 to release the reversible adhesive 16, thereby allowing the cable ends to detachably couple to the adhesive 16. The at least one or more apertures 30 may include an opening, hole and the like. The size of the aperture 30 may be varied depending to several factors including size of the cable, size of the tag, manufacturing constraints and the like. Also, the tag 12 may have at least one cable end permanently attached via a mechanical mechanism, permanent adhesive or other mechanisms known in the art so as to allow only one end of the cable to be detachably coupled to the tag 12.

FIG. 5 shows a hard tag 32 with the cover removed, exposing the interior portion 34 of the hard tag 32. The hard tag 32 includes an EAS element 20 and/or RFID element 22, reversible adhesive 16 area, and apertures 30 on opposite sides of the hard tag 32. In particular, the reversible adhesive 16 may be coated on at least part of an interior portion 34 of the hard tag 32 in which each aperture 30 provides access to the reversible adhesive 16. Each end of the cable 26 may be inserted into a different aperture 30 in order to be detachably coupled to the reversible adhesive 16. Alternatively, the hard tag 32 may have only one aperture 30 through which both ends of the cable 26 may be inserted in order to detachably couple the cable ends to the reversible adhesive 16. Moreover, additional apertures 30 and/or cable ends and/or reversible adhesive areas may be added at various parts of the hard tag 32.

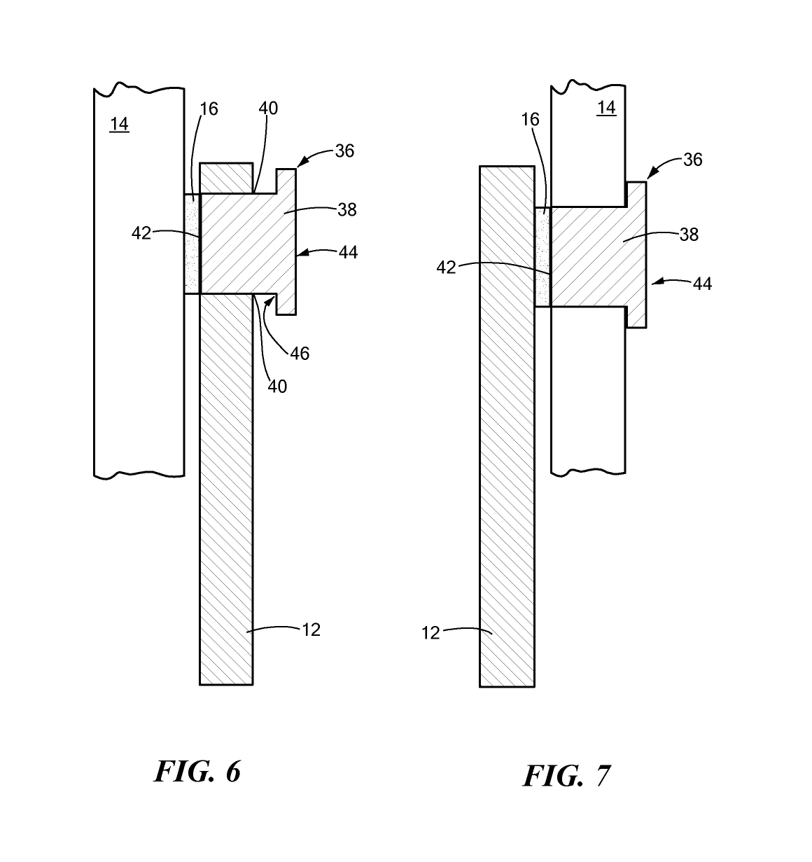

Referring to FIG. 6, a tag 12 with a releasable fastener 36 is illustrated. The releasable fastener 36 may include an anchor 38 with a reversible adhesive 16, thereby allowing the releasable fastener 36 to be detachably coupled to the article 14. The tag 12 may have an aperture 40 having a diameter (D_{tag}) through which a portion of the releasable fastener 36 may be positioned. In particular, the releasable fastener 36 may have at least two ends opposite each other, in which the diameter (D1) of the first end 42 may be smaller than the tag aperture 40 and the diameter (D2) of the second end 44 may be larger than the tag aperture 40. Reversible adhesive 16 is applied to the first end 42. Once the first end 42 of the releasable fastener is inserted into the aperture 40, the second end 44 of the anchor 38 may help secure the tag 12. In particular, the second end 44 may define a lip 46 that prevents the tag 12 from being removed. Moreover, the configuration illustrated in FIG. 6, may allow for different types of tags to be removably secured to an article 14. For example, a store owner may want certain articles to include only an EAS element 20 and other articles to include both an EAS element 20 and RFID element 22. In this case, the store owner may configure the appropriate tag to the article 14 by inserting the anchor 38 into a specific type of tag and detachably coupling anchor 38 to the article 14.

Furthermore, separating the tag 12 and reversible adhesive 16 into removable parts of the security tag may reduce the cost of upgrading or replacing the security tag. For example, once the reversible adhesive 16 becomes worn down and fails to adequately adhere to the article 14, only a replacement anchor 38 with reversible adhesive 16 needs to be ordered as opposed to ordering a complete security tag with reversible adhesive 16 and EAS/RFID element(s). Also, as other technologies emerge in the field of electronic article surveillance, there may be a need to update the tag 12 to a newer technology. Using the configuration of FIG. 6, only the tag 12 needs to be replaced. As such, the cost of replacing or upgrading parts of the security tag may be partitioned so that the user is purchasing only the needed part(s).

FIG. 7 illustrates an alternative embodiment of the tag 12 with a releasable fastener 36. In particular, the releasable fastener 36 may be removably coupled to the tag 12 through the article 14. The releasable fastener 36 may have a first end 42 and a second end 44 opposite the first end 42, each end having a respective diameter. The article 14 may include aperture 40, e.g., a button hole, having a diameter (D_{article}). In particular, the releasable fastener 36 may have the reversible adhesive 16 disposed on at least a portion of the first end 42. The first end 42 may be removably insertable into the aperture of the article. In particular, the diameter of the first end may be less than the diameter of the aperture (D_{article}). The second end of the releasable fastener 36 may have a diameter (D2) greater than the diameter of the aperture (D_{article}). As such, detachably coupling the releasable fastener 36 to the tag 12 through the article 14 secures the article 14 between releasable fastener 36 and tag 12.

Moreover, article 14 is not in contact with the reversible adhesive 16, thereby helping prevent damage to the article 14, e.g., helps prevent ripping the article when taking off the releasable fastener 36 with or without the using the source 18. Also, this configuration may allow the tag 12 with releasable fastener 36 to be used with any article 14 having a sufficiently sized aperture; even if article 14 has a surface that the reversible adhesive 16 cannot adhere to, i.e., the fastener cannot bond sufficiently to the article 14. As such, the embodiment of FIG. 7 may allow the security tag 12 to be use in combination with a wide variety of articles.

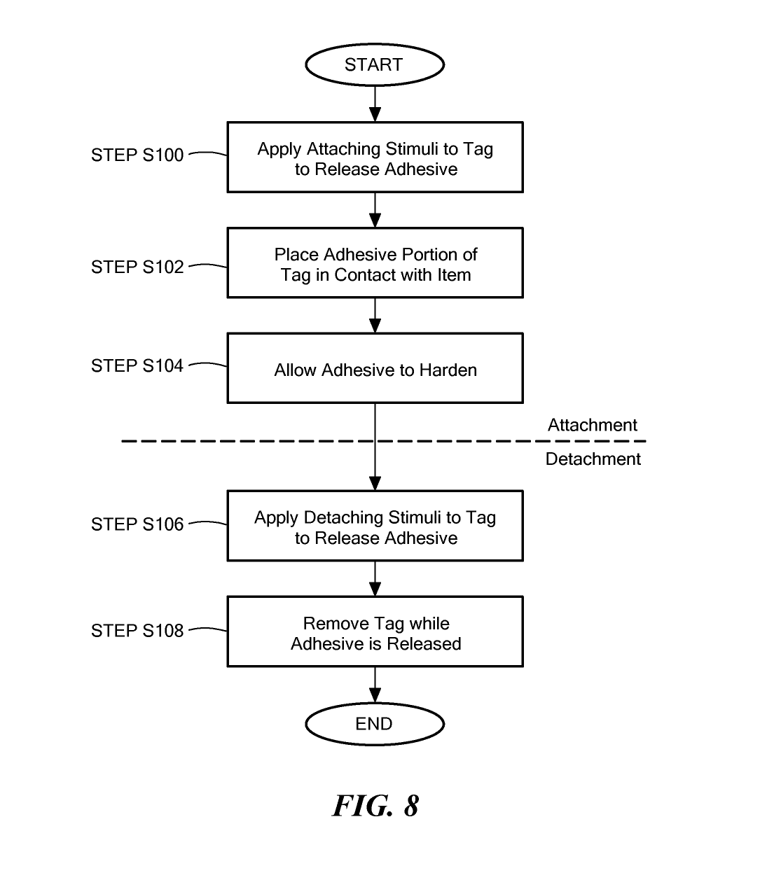

FIG. 8 illustrates an exemplary process by which a tag 12 having a reversible adhesive 16 may be attached to and subsequently detached from article 14. An attaching stimuli is applied to the tag 12 to release the reversible adhesive 16, e.g., thermally affect the reversible adhesive 16 (Block S100). The attaching stimuli or signal may originate from the signal generator discussed above, e.g., EM signal generator. Once the reversible adhesive 16 is sufficiently released, the attaching stimuli may be removed and the reversible adhesive 16 portion of the tag 12 may be placed into contact with the article 14 and/or the cable(s) 26, 28 may be placed into contact with the reversible adhesive 16 (Block S102). The reversible adhesive 16 will bond with the article 14 and/or cables(s) 26, 28 to detachably couple the tag 12 and the article 14 and/or cable(s) together. The amount of time needed to bond may vary depending on the reversible adhesive 16 used, the area of the reversible adhesive 16 coating, on the amount of attaching stimuli applied and the like (Block S104). For example, the more the reversible adhesive 16 is thermally affected, the longer it may take to bond. As such, the tag 12 with reversible adhesive 16 may be attached by using the attaching stimuli to thermally affect the reversible adhesive 16.

The tag 12 may be removed by applying a detaching stimuli to the tag 12 in order to release the reversible adhesive 16 (Block S106) and remove the tag 12 (Block S108). The detaching stimuli may be substantially the same signal 24 and duration as the attaching stimuli, i.e., both stimuli may release the reversible adhesive 16 to a similar degree, thereby simplifying the system 10. Alternatively, both stimuli may also be different in both signal 24 and duration. For example, the signal 24 and duration of the attachment stimuli may be configured so that the reversible adhesive 16 is released only enough to allow adhesion to the article 14. In other words, portions of the reversible adhesive 16 may remain relatively bonded while other portions may be released such as the portion being detachably coupled to the article 14 and/or cable 26. This may decrease the amount of time needed for the adhesive to bond. On the other hand, the detaching stimuli may be different than the attaching stimuli in order to greater thermally affect the reversible adhesive. In particular, more thermal energy may be needed to ensure all the reversible adhesive 16 releases in order to help prevent damage to the article/item. For example, the entire region of the reversible adhesive 16 may be released in order to help prevent a portion of the article 14 from remaining on the tag 12 after removal from the article 14. This will prevent tearing a portion of the article 14.

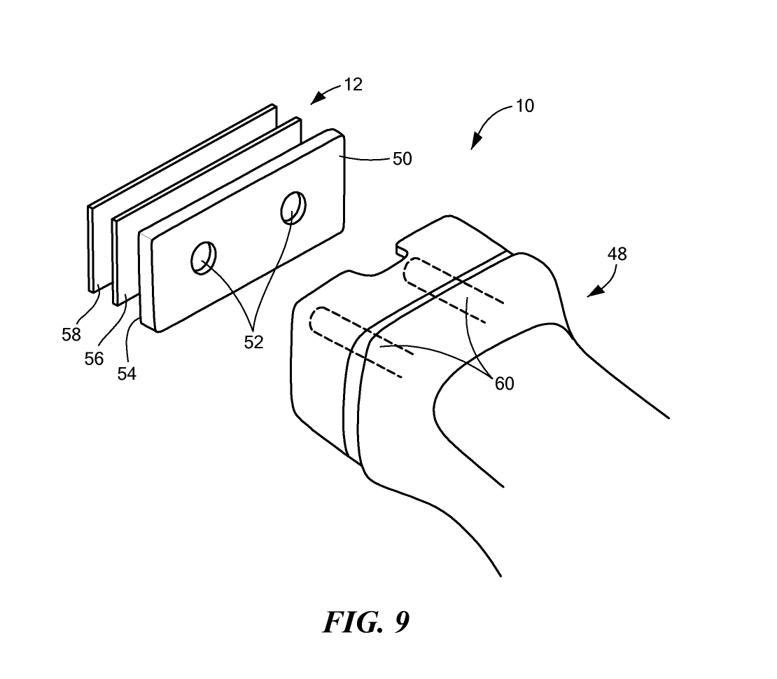

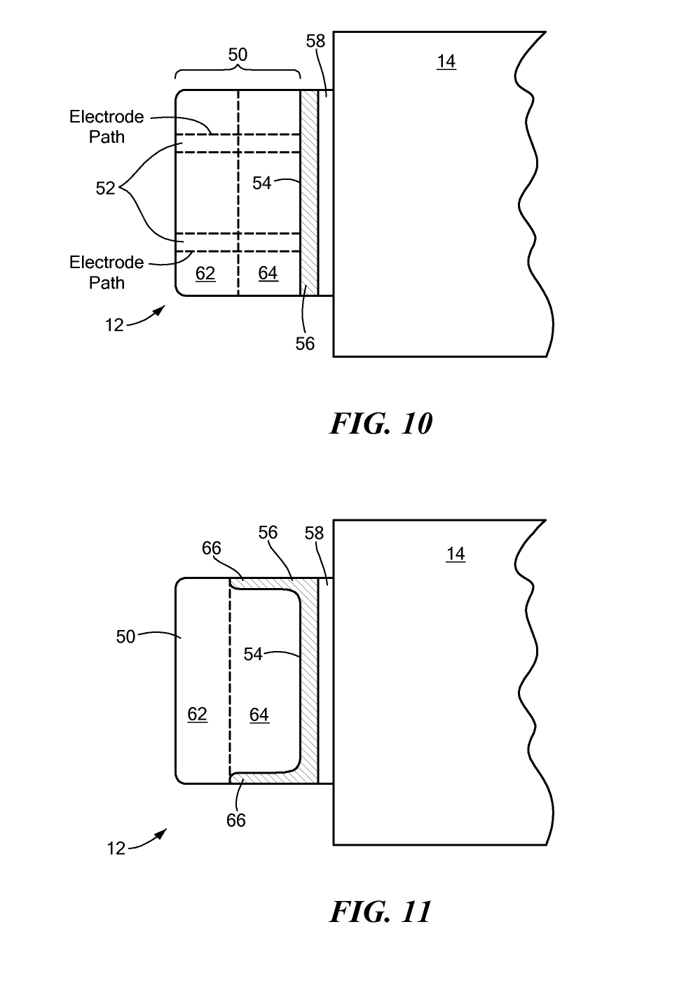

Referring to FIG. 9, a perspective view of an alternative security tag system 10 is illustrated. System 10 includes tag 12 and tag removal device 48. Tag 12 includes housing 50 that is releasably attachable to article 14, as discussed in detail with respect to FIG. 10. Housing 50 may be a hollow shell composed of plastic or other materials known in the art. While housing 50 is shown having a substantially cuboid or rectangular prism shape, housing 50 may have other geometric and/or non-geometric shapes based on design need. For example, housing 50 may be shaped to be received and/or substantially grasped/held by tag removal device 48 for tag 12 removal.

Housing 50 may include one or more apertures 52 (collectively referred to as “aperture 52”), metal element 56 and first reversible adhesive layer 58. Aperture 52 is arranged to receive one or more electrodes 60 (collectively referred to as “electrode 60”) from tag removal device 48 such that electrode 60 makes contact with metal element 56 for conductive heating. While electrode 60 is illustrated having a substantially cylindrical shape, electrode 60 may be arranged to have other geometric and/or non-geometric shapes. Aperture 52 allows access to metal element 56 through housing 50 or from outside housing 50. While aperture 52 is shown being substantially cylindrical in shape, one of ordinary skill in the art will recognize that aperture 52 may be other geometric and/or non-geometric shapes based on design need. In an alternative embodiment, aperture 52 may be omitted from housing 50 when access to metal element 56 through housing 48 is not needed, i.e., when tag removal device 48 has electrode contacts on the side of housing 50, as discussed in detail with respect to FIG. 11, or when metal element 56 is thermally affected through inductive heating, as discussed in detail with respect to FIG. 18.

Metal element 56 may be a metal film, screen or strip with metal materials such as aluminum, iron or other metals that are adapted to be heated. In particular, metal element 56 is deposited directly housing 50, i.e., deposited on at least a portion of outer surface 54, i.e., outer surface 54 provides a bonding surface for metal element 56. For example, metal element 56 may be sputtered on housing 50 to make metal element 56 thin, thereby increasing the resistance of metal element 56 such that more energy transfer is provided, i.e., more heat is generated to detach tag 12, which decreases de-bonding time by generating more heat in a short amount of time. Decreasing the size and/or thickness of metal element 56 also reduces the adverse impacts metal element 56 has on EAS element 20, i.e., less metal to interfere with EAS signals.

Metal element 56 is adapted to be thermally affected or heated by application of a signal from tag removal device 48. In one embodiment, metal element 56 has a thickness of approximately 0.05 mm, although other metal element 56 thicknesses may be used based on design need. Tag 12 further includes first reversible adhesive layer 58 that is releasably attached to metal element 56 and article 14, i.e., the metal element 56 provides a bonding surface for first reversible adhesive layer 58. At least a portion of first reversible adhesive layer 58 de-bonds when thermally affected by metal element 56 when metal element 56 is heated. Metal element 56 is directly attached to housing 50, i.e., directly attached or deposited to outer surface 54 of housing 50 such that metal element 56 provides a bonding surface for first reversible adhesive layer 58. Depositing metal element 56 directly on outside surface 54 of second housing portion 64 (FIGS. 10, 11 and 14) eliminates the requirement for an additional reversible adhesive layers needed to releasable affixed metal element 56 to housing 50, thereby reducing manufacturing complexity and cost. Also, having less reversible adhesive layers reduces the time required to heat first reversible adhesive layer 58, i.e., reversible adhesive layer attached to article 14, because of decreased total adhesive volume.

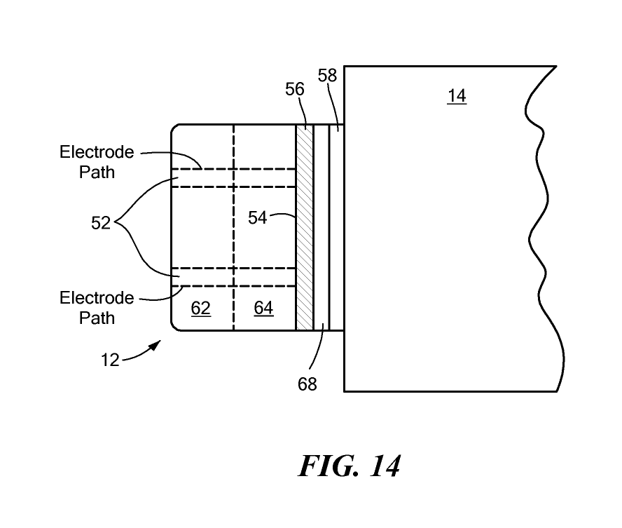

Tag removal device 48 is configured to generate a signal to thermally affect a reversible adhesive. For example, tag removal device 48 may apply a signal to metal element via two or more electrodes 60 (collectively referred to as “electrode 60”) such that an electric current is generated across metal element 56, thereby thermally affecting or conductively heating metal element 56 to approximately eight hundred degrees Celsius. Alternatively, the generated signal may be an electro-magnetic field applied to metal element to inductively heat metal element 56. Tag 12 may also include a fluid reservoir configured dispense denial of benefit fluid if an attempt is made to remove the housing from the article while tag 12 is still releasably attached to article 14, i.e., while the first reversible adhesive and/or second reversible adhesive (FIGS. 14-16) are below a predefined de-bonding temperature. Tag 12 provides the advantage of avoiding the use of a mechanical locking system such that the tag may be produced using automated production methods, which helps lower product cost and complexity.

A cross-section view of tag 12 is described with reference to FIG. 10. Tag 12 has first reversible adhesive layer 58 arranged to releasably attached tag 12 to article 14. Tag 12 includes housing 50 in which housing 50 has first housing portion 62 and second housing portion 64 that define an inner volume when mated. First housing portion 62 and second housing portion 64 may be joined to each other by ultrasonic welding, snap fitting or other joining method known in the art. Housing 50 may include aperture 52 that allows metal element 56 to be accessed outside of housing 50, i.e., electrodes 66 are removably insertable into aperture 52 and through electrode path allowing electrodes 66 to make contact with a portion of metal element 56. In particular, first housing portion 62 and/or second housing portion 64 include aperture 52. Alternatively, metal element 56 may be inductively heated such that aperture 52 may be omitted from housing 50. Both first housing portion 62 and second housing portion 64 have aperture 52 such that electrode 60 is able to access metal element 62 through both first housing portion 52 and second housing portion 54. EAS element 20 and/or RFID element 22 (not shown) may be disposed within the inner volume of housing 50. First reversible adhesive layer 58 is arranged to releasably attach metal element 56 and/or article 14 in which metal element 56 is a bonding surface for first reversible adhesive layer 58. While metal element 56 is illustrated being substantially planar, one of ordinary skill in the art will recognize that metal element 56 may be other geometric and/or non-geometric shapes.

Referring to FIG. 11, there is illustrated an alternative configuration of metal element 56 that may be thermally affected by conductive heating. Similar to FIG. 10, tag 12 has first reversible adhesive layer 58 releasably attached to metal element 56 in which metal element 56 is attached to housing 50, i.e., attached or deposited to outer surface of second housing portion 64 such that outer surface 54 provides a bonding surface for first reversible adhesive layer 58. At least a portion of metal element 56 extends around at least a portion of housing 50, i.e., extends around at least a portion of first and/or second housing portions. The one or more extended portions 66 (collectively referred to as “extended portion 66”) of metal element 56 are arranged to be accessible to tag removal device 48 without electrode 60 having to travel through aperture 52. Eliminating aperture 52 from housing 50 reduces the areas on tag 12 where a thief may be able to leverage tag 12 off article 14, i.e., a thief will not be able to insert a screwdriver in aperture 52 to try to pry off tag 12. Furthermore, extended portion 66 may be shaped to mate with electrode 60 of tag removal device 48 such that tag removal device 48 grasps tag 12 and conductively heats metal element 56 via electrodes 60. Also, electrode 60 may be shaped to grasp tag 12 while at the same time accessing extended portion 66. Metal element 56 may also be arranged to be inductively heated for use with multiple tag removal devices.

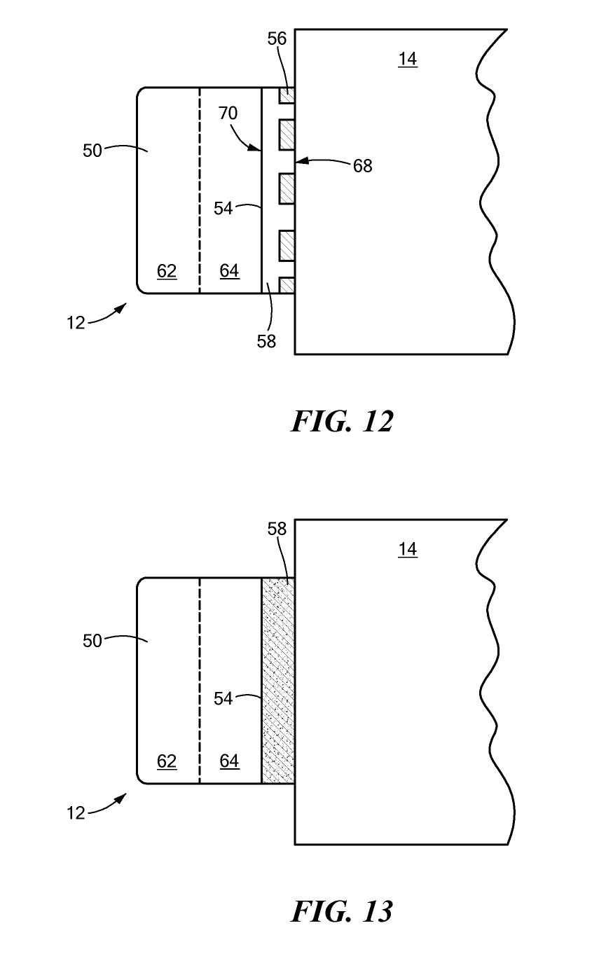

A cross-section view of an alternative embodiment of tag 12 is illustrated in FIG. 12. Tag 12 includes housing 50, first reversible adhesive layer 58 and metal element 56. First reversible adhesive layer 58 is releasable attached to housing 50, i.e., attached to outer surface 54 of second housing portion 64 such that outer surface 54 provides a bonding surface for first reversible adhesive layer 58. In particular, metal element 56 is distributed throughout first reversible adhesive layer 58 on an article side 68 of first reversible adhesive layer 58 opposite the tag side 70 of first reversible adhesive layer 58 facing housing 50, i.e., metal element 56 is distributed on the side of first reversible adhesive layer 58 that releasably attaches to article 14 such that first reversible adhesive layer 58 provides a bonding surface for metal element 56. Both metal element 56 and first reversible adhesive layer 58 abut or lie next to article 14. Distributing metal element 56 on the article side of first reversible adhesive layer 58 provides the benefit of thermally affecting the reversible adhesive on the article side 68 of first reversible adhesive layer 58 before thermally affecting the adhesive on the tag side 54, i.e., the reversible adhesive on article side 68 de-bonds or reaches the de-bonding temperature before reversible adhesive on tag side 70, thereby helping prevent left over reversible adhesive residue on article 14.

An alternative embodiment of security tag 12 is illustrated in FIG. 13. Tag 12 is substantially similar to tag 12 described with respect to FIG. 2. Housing 50 is sized to be received by tag removal device 48 such that tag removal device 48 grasps or grips tag 12 for removal. Outer surface 54 of second housing portion 64 provides a bonding surface for first reversible adhesive layer 58 such that first reversible adhesive layer 58 is releasably attached to housing 50. First reversible adhesive layer 58 is arranged to releasably attach to article 14. In particular, first reversible adhesive layer 58 may contain a ferromagnetic or metallic additive such that metal element 56 may be omitted. When a high frequency EM field is applied to tag 12, the paramagnetic particles will oscillate and, in turn, heat first reversible adhesive layer 58, i.e., thermally affect the reversible adhesive, in order to release first reversible adhesive layer 58. Tag 12 may be arranged to mate with tag removal device 48. The paramagnetic particles may be Carbon black, iron (Fe) or iron (III) oxide (Fe2O3) particles.

With reference to FIG. 14, there is illustrated another alternative embodiment of security tag 12. In particular, security tag 12 includes housing 50, metal element 56, first reversible adhesive layer 58 and second reversible adhesive layer 68. Metal element 56 is disposed on housing 50 such as by sputtering. Second reversible adhesive layer 68 is releasably or permanently attached to metal element 56 in which first reversible adhesive layer 58 is releasable attached to second reversible adhesive layer 68, i.e., outer surface 54 of second housing portion 64 provides a bonding surface for metal element 56 while metal element 56 provides a bonding surface for first reversible adhesive layer 58. Second reversible adhesive layer 68 de-bonds at a higher temperature than first reversible adhesive layer 58. The first reversible adhesive layer 58 is arranged to releasably attach to article 14. Alternatively, second reversible adhesive layer 68 may be a non-reversible adhesive layer that is remains substantially bonded to metal element 56.

When metal element 56 is thermally affected by tag removal device 48 via inductive or conductive heating, second reversible adhesive layer 68 is thermally affected, which in turn thermally affects first reversible adhesive layer. In other words, metal element 56 indirectly thermally affects first reversible adhesive layer 58 by directly affecting second reversible adhesive layer 68. Because second reversible adhesive layer 68 de-bonds at a higher temperature than first reversible adhesive layer 58, second reversible adhesive layer 68 remains bonded to housing 50 while first reversible adhesive layer 58 releases from article 14. While metal element 56 is illustrated being substantially planar, metal element may be include other geometric and/or non-geometric shapes. Metal element 56 may have a one or more extended portions 66 similar to the configuration described in FIG. 11.

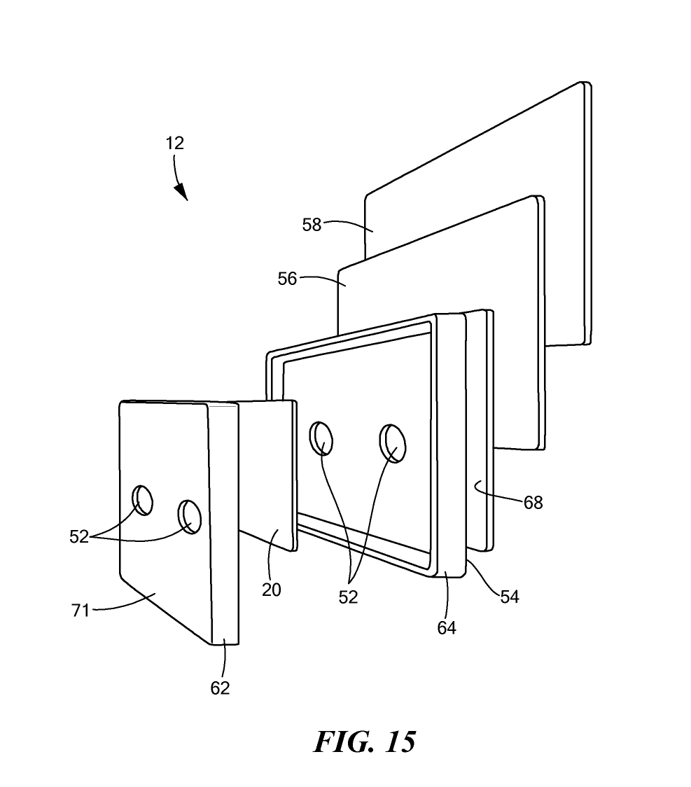

FIG. 15 illustrates an exploded view of another embodiment of tag 12. First housing portion 62 has an outer surface 71 facing opposite the inner volume of housing 50 while second housing portion 64 has an outer surface 54 facing opposite the inner volume of housing 50. Second reversible adhesive layer 68 is releasably attached to the outer surface 54 of second housing portion 64, i.e., the outer surface 54 of second housing portion 64 provides a bonding surface for second reversible adhesive layer 68. Second reversible adhesive layer 68 is arranged to temporarily release, i.e., de-bond, uncure, soften and the like, from one or more surfaces at a higher temperature than first reversible adhesive layer 58 upon application of an energy source such as from tag removal device 48. In other words, at least a portion of first reversible adhesive layer 58 de-bonds when thermally affected by metal element 56 when metal element 56 is heated. Alternatively, second reversible adhesive layer 68 may be non-reversible adhesive layer that remains substantially bonded to second housing portion 64 and metal element 56 while first reversible adhesive layer 58 is releasably attached to article 14.

First and second reversible adhesives layers may be arranged to be thermally affected by at least one of conductive and inductive heating of metal element 56. Second reversible adhesive layer 68 is arranged such that electrodes 60 are able to make contact with metal element 56, i.e., second reversible adhesive layer 68 is applied to outer surface 54 of second housing portion 64 such that metal element 56 is accessible via aperture 52.

Security tag 12 includes metal element 56 releasably attached or permanently attached, depending on the type of adhesive used, to second reversible adhesive layer 68. In other words, second reversible adhesive provides a bonding surface for metal element 56. Tag 12 further includes first reversible adhesive layer 58 that is releasably attached to metal element 56 and article 14, i.e., metal element 56 provides a bonding surface for first reversible adhesive layer 58. In particular, first reversible adhesive layer 58 is arranged to releasably attach tag 12 to article 14. In one embodiment, the total thickness of tag 12 is approximately 5 mm in which the low profile of the tag 12 increases the difficulty to defeat tag 12, i.e., increases the difficulty of grabbing tag 12 with bare hands or ordinary tools such that a thief will have a hard time removing tag 12.

Moreover, first reversible adhesive layer 58 may be replaced by double sided adhesive tape or laminate. For example, first reversible adhesive layer 58 may be double sided adhesive tape in which a second adhesive side of the adhesive tape releasably attaches to metal element 56 and a first adhesive side of the adhesive tape releasably attaches to article 14 in which the first adhesive side de-bonds at a lower temperature than the second adhesive side. The first and second adhesive sides of the double sided tape may be coated with the same reversible adhesive or with different reversible adhesives, e.g., first adhesive side may be coated with the second reversible adhesive while the second adhesive side is coated with the first reversible adhesive. Alternatively, one of the adhesive sides of double sided tape may be coated with a non-reversible adhesive, e.g., second adhesive side of adhesive tape is coated with non-reversible adhesive. Aperture 52 may be openings of one or more conduits that guide electrodes 78 from first housing portion 52 to metal element 56, e.g., conduits to/from first housing portion 62 from/to second housing portion 64.

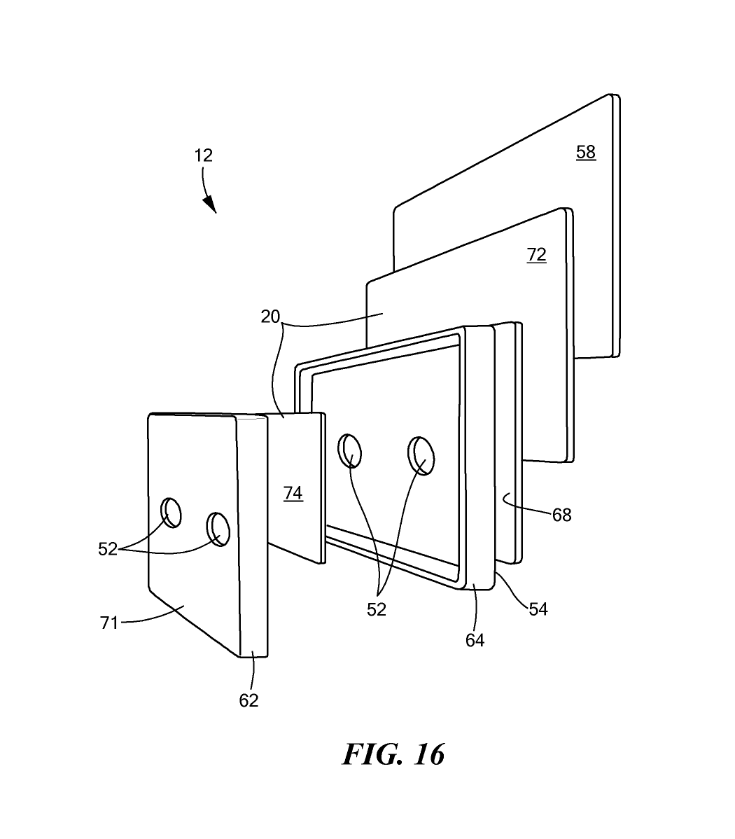

A perspective view of an alternative embodiment of tag 12 is described with reference to FIG. 16. The configuration of security tag 12 is similar to security tag 12 of FIG. 15 except that components of EAS element 20 have been separated in which metal element 56 is replaced with one of the components of EAS element 20. In particular, EAS element 20 includes bias element 72 and resonator 74 in which resonator 74 remains disposed within housing 50 while bias element 72 is disposed outside of housing 50. Bias element 72 and resonator 74 are arranged to provide EAS element 20 functionality even though one component of EAS element 20 is located outside tag 12, i.e., bias element 72 biases resonator 74.

First reversible adhesive layer 58 is arranged to be thermally affected by bias element 72 when bias element 72 is heated. For example, bias element 72 is thermally affected by tag removal device 48 via inductive or conductive heating, similar to metal element 56, which in turn thermally affects first reversible adhesive layer 58. Using bias element 72. i.e., a component of EAS element 20, to replace metal element 56 in order to thermally affect or heat first reversible adhesive layer 58 allows tag 12 to be releasably attached to article 14 without the need for metal element 56, thereby reducing manufacturing cost and complexity. In one embodiment, bias element 72 is 0.5 inches wide and 2 inches long. Bias element 72 may be made from MAGNEDUR alloy with a thickness of 2 mils or 4 mils. Other bias element materials and sizes may be used that in accordance with the principles of the invention.

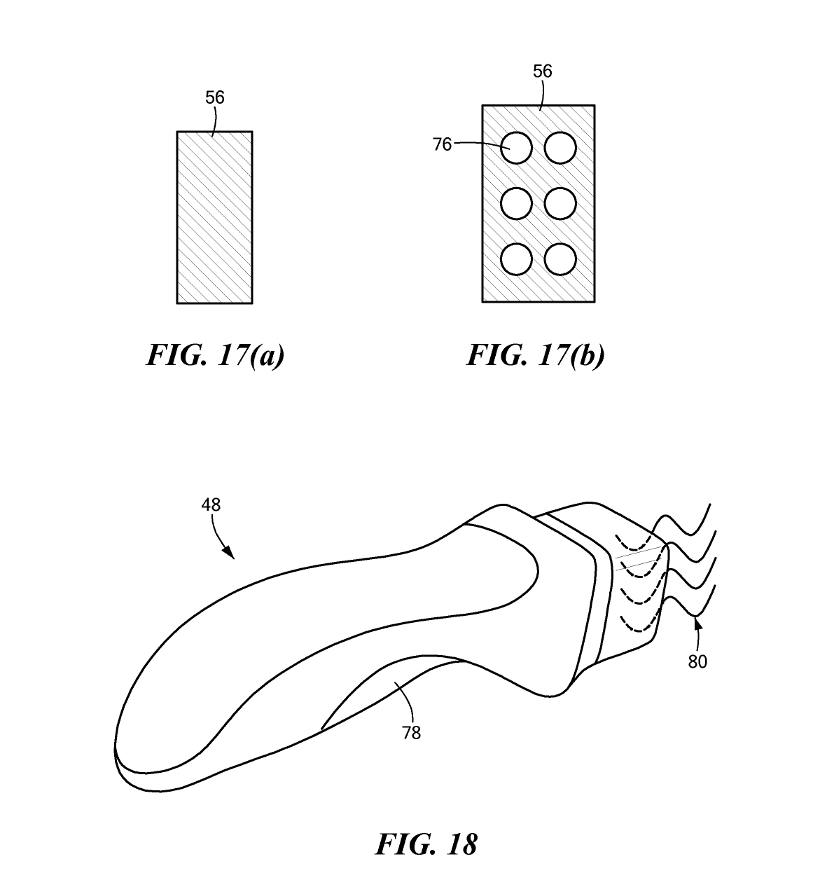

FIG. 17(a)-(b) illustrate different embodiments of metal element 56. While metal element 56 is illustrated in FIG. 17(a)-(b) having a substantially geometrically shape, metal element 56 may have other geometric and/or non-geometric shapes. With reference to FIG. 17(b), metal element 56 may have one or more apertures 76 in which apertures 76 may be geometrically and/or non-geometrically shaped. Apertures 76 allows a reversible adhesive on one side of metal element 56 to releasably attach to article 14 adjacent to the other side of metal element 56 similar to the configuration of FIG. 12. While metal element 56 is illustrated being one piece, metal element 56 may alternatively be a plurality of metal sections, unconnected to each other, that may be inductively heated.

An exemplary tag removal device 48 is described with reference to FIG. 18. Tag removal device 48 thermally affects metal element 56 by inductive heating. An electro-magnetic field is emitted by tag removal device 48 such that heat can be induced through eddy current loss, in a highly conductive metal, or magnetic loss through ferromagnetic material. In particular, tag removal device 48 generates signal or electromagnetic power/field 80 when button 78 is pressed. In one embodiment, signal 80 may be an electro-magnetic field having a peak power of approximately 500 watt and frequency of approximately 30 kHz such that metal element 56 is heated in approximately three seconds.

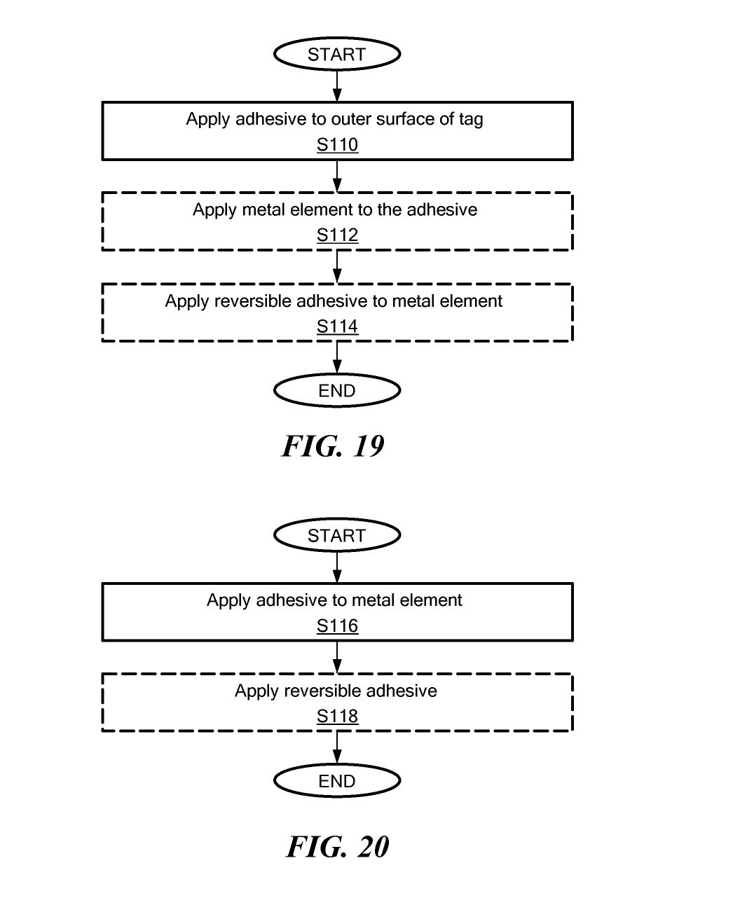

FIG. 19 is a flow chart of an exemplary process for producing tag 12 in accordance with the principles of the present invention. Of note, the process of FIG. 19 is applicable to the embodiments of FIGS. 12, 13, 15 and 16 in which an adhesive is placed in direct contact with housing 50. An adhesive, e.g., first reversible adhesive, second reversible adhesive, permanent adhesive or first reversible adhesive with ferromagnetic particles, is applied to outer surface 54 of tag 12 (Block S110). Metal element 56 is applied to the adhesive such that metal element 56 is releasably attached to the adhesive (Block S112). Metal element 56 may be metal element 56 (FIG. 15) or bias element 72 (FIG. 16). Alternatively, Block S112 may be skipped based on design need such as when producing tag 12 of FIG. 13 where first reversible adhesive layer 58 releasably attaches to article 14. A reversible adhesive, e.g., first reversible adhesive layer 58, is applied to metal element 56 or bias element 72 such that metal element 56 releasably attaches to the reversible adhesive (Block S114). For example, as illustrated in FIG. 15, the reversible adhesive layer, i.e., first reversible adhesive layer 58, is applied to metal element 56. In another embodiment illustrated in FIG. 16, the reversible adhesive, i.e., first reversible adhesive layer 58, is applied to bias element 72. A cover may be releasably attached to the reversible adhesive such that an employee can peel over the cover off the reversible adhesive and attached tag 12 to article 14, e.g., first reversible adhesive 64 is removably attached to article 14.

With respect to FIG. 20, an exemplary process for producing an alternative embodiment of tag 12 having metal element 56 disposed on outer surface 54 of tag 12 is described in accordance with the principles of the present invention. Of note, the process of FIG. 20 is applicable to the embodiments of FIGS. 9, 10, 11 and 14 where metal element 56 is in contact with housing 50. An adhesive layer is applied to metal element 56 that is disposed on outer surface 54 of tag 12, e.g., first reversible adhesive layer 58, second reversible adhesive layer 64 or a permanent adhesive layer is applied to metal element 56 (Block S116). For example, first reversible adhesive layer 58 is applied to metal element 56 as illustrated in FIGS. 9, 10 and 111. In another example, second reversible adhesive layer 68 is applied to metal element 56 as illustrated in FIG. 14. A reversible adhesive layer is then applied (Block S118). For example, first reversible adhesive layer 58 is applied to second reversible adhesive layer 68. Alternatively Block S118 may be omitted based on design need.

Unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A loss prevention system for protecting an article, comprising:
a security tag having:
a housing;
a metal element, the metal element adapted to be heated; and
a first reversible adhesive proximate the metal element, at least a portion of the first reversible adhesive de-bonding when thermally affected by the metal element when the metal element is heated.

2. The system of claim 1, wherein the housing defines an inner volume; and
the security tag further includes an electronic article surveillance (EAS) element arranged to emit a detectable signal when introduced to an interrogation signal, the EAS element including:
a bias element, the metal element being bias element and being disposed outside the housing; and
a resonator, the resonator being disposed within the inner volume of the housing.

3. The system of claim 2, wherein the first reversible adhesive is releasably affixed to at least a portion of the metal element.

4. The system of claim 1, further comprising a tag removal device arranged generate a signal to heat the metal element by one of conductive heating and inductive heating.

5. The system of claim 4, wherein the housing further includes a plurality of apertures, the plurality of apertures allowing access to the metal element through the housing; and
the tag removal device further includes a plurality of electrodes removably insertable into the plurality of apertures to conductively heat the metal element.

6. The system of claim 4, wherein the tag removal device further includes a plurality of electrodes; and
the metal element extending around at least a portion of the housing, the extended portion of the metal element being accessible by the plurality of electrodes to conductively heat the metal element when the plurality of electrodes access the extended portion of the metal element.

7. The system of claim 4, wherein the tag removal device is arranged to emit the generated signal to inductively heat the metal element.

8. The system of claim 1, wherein the metal element includes a first side and second side opposite the first side, the first side releasably attached to the first reversible adhesive, at least a portion of the second side abutting the article when the first reversible adhesive is removably attached to the article.

9. The system of claim 1, wherein the metal element is a plurality of metal particles distributed throughout the first reversible adhesive.

10. The system of claim 1, wherein the housing further includes an outer surface, the metal element being deposited on the outer surface of the housing to create a bonding outer surface for a second reversible adhesive; and
the second reversible adhesive being disposed on the bonding outer surface, the second reversible adhesive attaching the first reversible adhesive to the housing, the second reversible adhesive de-bonding at a higher temperature than the first reversible adhesive.

11. A security system tag, comprising:
a housing;
an electronic article surveillance, EAS, element, the EAS element arranged to emit a detectable signal when introduced to an interrogation signal;
a metal element, the metal element adapted to be heated; and
a first reversible adhesive proximate the metal element, at least a portion of the first reversible adhesive de-bonding when thermally affected by the metal element when the metal element is heated.

12. The security tag of claim 11, wherein the housing further includes a fluid reservoir, the fluid reservoir arranged to dispense denial of benefit fluid if an attempt is made to remove the housing from the article while the first reversible adhesive is below a predefined temperature.

13. The system of claim 11, further comprising a double sided adhesive tape having:
a first side, the first reversible adhesive being disposed on the first side; and
a second side, a non-releasable adhesive being disposed on the second side and attached to the metal element.

14. The system of claim 11, wherein the metal element is a plurality of metal particles, the plurality of metal particles being distributed throughout the first reversible adhesive.

15. The system of claim 11, wherein at least a portion of the metal element is configured to abut the article when the first reversible adhesive is removable adhered to the article.

16. The system of claim 11, wherein the housing defines an inner volume; and
the EAS element including:
a bias element, the metal element being the bias element and being disposed outside the housing; and
a resonator, the resonator being disposed within the inner volume.

17. The system of claim 11, further comprising a second reversible adhesive, the second reversible adhesive attaching the housing to the first reversible adhesive, the second reversible adhesive de-bonding at a higher temperature than the first reversible adhesive.

18. A method, comprising applying a first reversible adhesive to a bonding surface of a security tag including a metal element, the first reversible adhesive arranged to:
releasably attach the security tag to an article; and
de-bond when thermally affected by the metal element when the metal element is heated.

19. The method of claim 18, further comprising applying a second reversible adhesive to the metal element; and
the bonding surface being the second reversible adhesive, the second reversible adhesive releasably attaching the security tag to the first reversible adhesive.

20. The method of claim 18, wherein the bonding surface is an outer surface of a housing of the security tag; and
the metal element is a plurality of metal particles, the first reversible adhesive having the plurality of metal particles distributed throughout the first reversible adhesive.
